(19) United States
(12) Patent Application Publication
(10) Pub. No.: US 2018/0254116 A1
(43) Pub. Date: Sep. 6, 2018

(54) SYSTEMS TO GENERATE TRANSIENT, ELEVATED EFFECTIVE MASS LECTRON QUASIPARTICLES FOR TRANSMUTING RADIOACTIVE FISSION PRODUCTS AND RELATED METHODS

(71) Applicant: Tionesta Applied Research Corporation, Sequim, WA (US)

(72) Inventors: Anthony Zuppero, San Diego, CA (US); Thomas J. Dolan, Ionia, IA (US)

(73) Assignee: Tionesta Applied Research Corporation, Sequim, WA (US)

(21) Appl. No.: 15/973,231

(22) Filed: May 7, 2018

Related U.S. Application Data
(63) Continuation-in-part of application No. 15/286,354, filed on Oct. 5, 2016, now abandoned.
Application No. 15/286,354 is a continuation-in-part of application No. 14/933,487, filed on Nov. 5, 2015, now abandoned.
Application No. 14/933,487 is a continuation-in-part of application No. PCT/US2015/059218, filed on Nov. 5, 2015.
(60) Provisional application No. 62/237,249, filed on Oct. 5, 2015.
(60) Provisional application No. 62/237,235, filed on Oct. 5, 2015.
(60) Provisional application No. 62/237,235, filed on Oct. 5, 2015.
(60) Provisional application No. 62/075,587, filed on Nov. 5, 2014.
(60) Provisional application No. 62/237,235, filed on Oct. 5, 2015.
(60) Provisional application No. 62/075,587, filed on Nov. 5, 2014.

(51) Int. Cl. G21G 7/00

(52) U.S. Cl. CPC G21G 7/00

(57) ABSTRACT

Some embodiments include systems to generate transient, elevated effective mass electron quasiparticles for transmuting radioactive fission products. Other embodiments of related systems and methods also are disclosed.

### CROSS-REFERENCE TO RELATED APPLICATIONS

This patent application is a continuation-in-part patent application of U.S. Non-Provisional patent application Ser. No. 15/286,354, filed Oct. 5, 2016 and entitled “GENERATOR OF TRANSIENT, ELEVATED EFFECTIVE MASS ELECTRON QUASIPARTICLES FOR TRANSMUTING RADIOACTIVE FISSION PRODUCTS.”

U.S. Non-Provisional patent application Ser. No. 15/286,354 claims the benefit of U.S. Provisional Patent Application No. 62/237,249, filed on Oct. 5, 2015 and entitled “MUON CATALYZED FUSION ATTRACTION REACTION,” and claims the benefit of U.S. Provisional Patent Application No. 62/237,235, filed on Oct. 5, 2015 and entitled “COMPOSITION ENABLING CONTROL OVER NEUTRALIZING RADIOACTIVITY USING MUON SURROGATE CATALYZED TRANSMUTATIONS AND QUANTUM CONFINEMENT ENERGY CONVERSION.” Further, U.S. Non-Provisional patent application Ser. No. 15/286,354 is a continuation-in-part patent application of U.S. Non-Provisional patent application Ser. No. 14/933,487, filed on Nov. 5, 2015 and entitled “COMPOSITION ENABLING CONTROL OVER NEUTRALIZING RADIOACTIVITY USING MUON SURROGATE CATALYZED TRANSMUTATIONS AND QUANTUM CONFINEMENT ENERGY CONVERSION,” and is a continuation-in-part patent application of International Patent Application No. PCT/US15/59218, filed on Nov. 5, 2015 and entitled “COMPOSITION ENABLING CONTROL OVER NEUTRALIZING RADIOACTIVITY USING MUON SURROGATE CATALYZED TRANSMUTATIONS AND QUANTUM CONFINEMENT ENERGY CONVERSION.”

U.S. Non-Provisional patent application Ser. No. 14/933,487 and International Patent Application No. PCT/US15/59218 each claim the benefit of U.S. Provisional Patent Application No. 62/237,235, and each claim the benefit of United States Provisional Patent Application No. 62/075,587, filed Nov. 5, 2014 and entitled “BINDING ENERGY CONVERTER USING QUANTUM CONFINEMENT, IONIC REACTANT TRANSPORT, AND EMITTING ELECTROMAGNETIC ENERGY.”

U.S. Non-Provisional patent application Ser. No. 15/286,354, U.S. Non-Provisional patent application Ser. No. 14/933,487, International Patent Application No. PCT/US15/59218, U.S. Provisional Patent Application No. 62/237,249, U.S. Provisional Patent Application No. 62/237,235, and U.S. Provisional Patent Application No. 62/075,587 are incorporated herein by reference in their entirety. If there are any conflicts or inconsistencies between this patent application and U.S. Non-Provisional patent application Ser. No. 15/286,354, U.S. Non-Provisional patent application Ser. No. 14/933,487, International Patent Application No. PCT/US15/59218, U.S. Provisional Patent Application No. 62/237,249, U.S. Provisional Patent Application No. 62/237,235, or U.S. Provisional Patent Application No. 62/075,587, however, this patent application governs herein.

### FIELD OF THE INVENTION

This disclosure relates generally to systems and methods to generate transient electron quasiparticles with elevated effective mass to form bonds unavailable to electrons with normal mass, and relates more particularly to systems and methods to generate transient electron quasiparticles with elevated effective mass to catalyze chemical reactions and nuclear transmutations, including transmuting radioactive isotopes into stable elements.

### DESCRIPTION OF THE BACKGROUND

Solid state systems can temporarily increase the apparent mass of an electron. The increase in apparent mass of the electron can result in the attraction and bonding of nuclear reactants by moving the nuclear reactants within range of their nuclear binding forces. When the nuclei of the nuclear reagents merge and bind, the binding and bonding energy can be concentrated into a single electron, leaving the product cold, in its ground state. At one time, direct production of a ground state from a highly energetic chemical process was considered impossible.

Additionally, placing a negative particle with sufficiently heavy effective mass between fusible nuclei can cause them to undergo fusion. For example, placing a muon between fusible nuclei can cause the nuclei to fuse, which can be referred to as muon catalyzed fusion. However, the negative particle does not need to be a muon or even a subatomic particle.

A need exists for improved systems and methods to generate negative particles to simulate chemical or nuclear attraction reactions to transmute reactants.

### BRIEF DESCRIPTION OF THE DRAWINGS

To facilitate further description of the embodiments, the following drawings are provided in which:

FIG. 1 illustrates a system configured to generate transient, elevated effective mass electron quasiparticles, according to an embodiment;

FIG. 2 illustrates a nominal band structure showing an inflection point and injection of both energy and momentum splatter for a reaction crystallite;

FIG. 3 illustrates a hydrogen atom can be injected into a reaction crystallite;

FIG. 4 illustrates the injection of the hydrogen atom of FIG. 3 into the reaction crystallite can cause waves of reaction crystallite atom motions;

FIG. 5 illustrates the waves of the reaction crystallite atom motions of FIG. 4 reverberating;

FIG. 6 illustrates the waves of FIGS. 4 & 5 beginning to relax and decay;

FIG. 7 illustrates particles in the dimension range of decay formed or placed on a suitable substrate;

FIG. 8 illustrates a system, according to an embodiment;

FIG. 9 illustrates band structures for palladium and palladium hydride;

FIG. 10 illustrates band structures for vanadium;

FIG. 11 illustrates band structures for nickel hydrides;

FIG. 12 illustrates band structures for titanium hydrides;

FIG. 13 illustrates a first plot of a total energy of a reactant/electron system as a function of a confinement coordinate of the electron;

FIG. 14 illustrates a second plot of an energy of the reactant/electron system of FIG. 13 as a function of a confinement coordinate of the electron;

FIG. 15 illustrates a third plot of an energy of the reactant/electron system of FIG. 13;

FIG. 16 illustrates a nominal band structure, showing a similarity of generating transient, elevated effective mass electron quasiparticles and converting photovoltaic energy in an indirect semiconductor such as silicon;

FIG. 17 illustrates a reactant A and a lower mass reactant B that are attracted to each other by an independent binding potential;

FIG. 18 illustrates a transition, or transmutation in the nuclear case, where reactant A and reactant B bind and the electron is ejected;

FIG. 19 illustrates the energy associated with the electron bond and with the AB product bond being shared between the ejected electron and a vibration state of the AB product, and a relatively small recoil;

FIG. 20 illustrates a circumstance where a unit attraction reaction does not result and a sigma ungerade bond forms, where the electron is bound to A or B;

FIG. 21 illustrates combined unit reactions using a common reactant A;

FIG. 22 illustrates combined unit reactions energize the bonding electrons inside a product nucleus BAB to form an intermediate nucleus;

FIG. 23 illustrates a way to use an energetic neutral particle emission for propulsion; and

FIG. 24 illustrates the relationship between binding, bonding and electron quantum kinetic energy as a function of effective mass.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

Various embodiments of systems and methods to generate transient, elevated effective mass electron quasiparticles (e.g., transient, sufficiently elevated effective mass electron quasiparticles) are described herein. For example, some embodiments can generate transient, elevated effective mass electron quasiparticles by injecting (e.g., simultaneously injecting) crystal momentum and energy to move some electrons to a desired location in a band structure diagram. Other embodiments may differ from the particular embodiments described herein.

In many embodiments, the elevated effective mass of a transient, elevated effective mass electron quasiparticle can comprise a sufficiently elevated effective mass. In these embodiments, a transient, elevated effective mass electron quasiparticle can be referred to as transient, sufficiently elevated effective mass electron quasiparticle. In some embodiments, a “sufficiently elevated effective mass” can refer to a threshold effective mass at which reactions (e.g., chemical or nuclear attraction reactions) can occur. For example, in some embodiments, a “sufficiently elevated effective mass” can refer to a threshold effective mass at which nuclear fusion reactions can occur.

In some embodiments, transient, sufficiently elevated effective mass electron quasiparticles can replace muons in reactions like muon catalyzed fusion reactions. In further embodiments, transient, sufficiently elevated effective mass electron quasiparticles can cause chemical or nuclear attraction reactions in or on a crystallite that are unavailable with normal mass electrons. In some embodiments, nuclear attraction reactions can apply to nuclear transmutations. An exemplary nuclear attraction reaction can comprise a transmutation of radioactive fission products into stable natural elements.

In some embodiments, using transient, sufficiently elevated effective mass electron quasiparticles to replace muons in reactions like catalyzed fusion can be advantageous to avoid using a particle accelerator to produce muons. For example, producing muons with a particle accelerator can be inefficient and require high energy. Further, with a particle accelerator, a density of muons produced in a target material can be so low that two muons are not present at the nucleus at the same time. Because of the low muon-to-target ratio, multi-body reactions involving two or more muons are statistically improbable.

As discussed further herein, some embodiments of the systems and methods can bring three fields of research together: (1) muon catalyzed fusion research regarding effective electron mass, (2) chemical physics research regarding placing bonding electrons “between” reactants, and (3) research regarding transiently elevating the effective mass of an electron in a crystal.

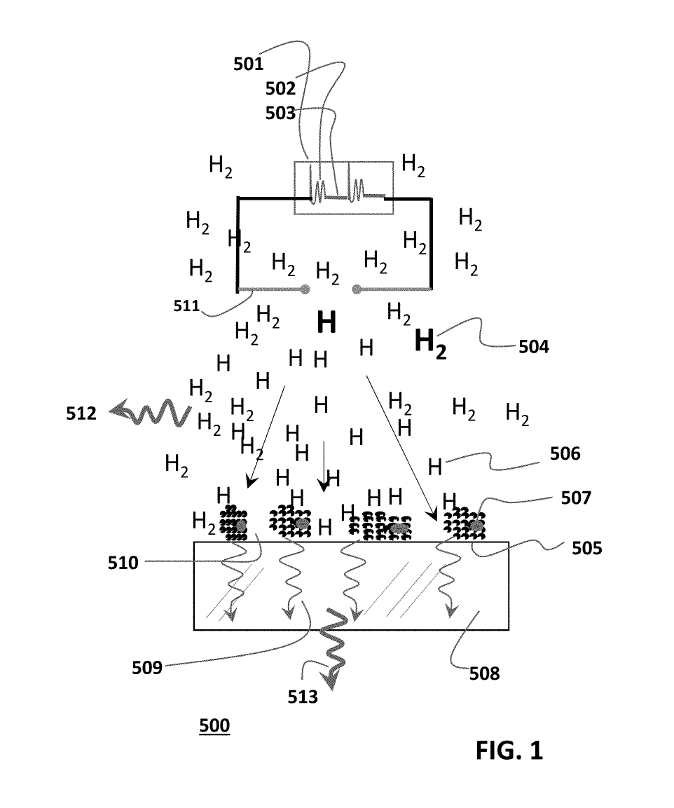

Turning to the drawings, FIG. 1 illustrates a system 500 configured to generate transient, elevated effective mass electron quasiparticles (e.g., transient, sufficiently elevated effective mass electron quasiparticles), according to an embodiment. System 500 is merely exemplary and is not limited to the embodiments presented herein. System 500 can be employed in many different embodiments or examples not specifically depicted or described herein.

In some embodiments, system 500 can generate transient, elevated effective mass electron quasiparticles (e.g., transient, sufficiently elevated effective mass electron quasiparticles) in or on a reaction crystallite 505. For example, system 500 can comprise hydrogen atoms 506 and a reactant nucleus 507 to be transmuted. For example, in some embodiments, the hydrogen atoms 506 can be generated and transported to the reaction crystallite 505, where the hydrogen atoms 506 adsorb, absorb and/or are injected into or on the reaction crystallite 505. Some of hydrogen atoms 506 can become delocalized (e.g., becoming reactant hydrogen atoms) in or on the reaction crystallite 505, and the injection can cause a distribution of transient, elevated effective mass electron quasiparticles (e.g., transient, sufficiently elevated effective mass electron quasiparticles) to form in the reaction crystallite 505, where reactions with the reactant nucleus 507 are stimulated.

In some embodiments, the reactant nucleus 507 can be located in or on the reaction crystallite 505. In many embodiments, system 500 can permit an electron bond to be formed where the electron bond has only a ground state between a reactant hydrogen atom of hydrogen atoms 506 and the reactant nucleus 507 with a distance between nuclei that can be accessed by tunneling. For example, the sufficiently elevated effective mass permitting a bond of this type between a hydrogen nucleus and a nickel-62 nucleus can be a quasiparticle electron effective mass of approximately 40 mₒ compared to 207 mₒ for a muon, where mₒ is the free space rest mass of an electron.

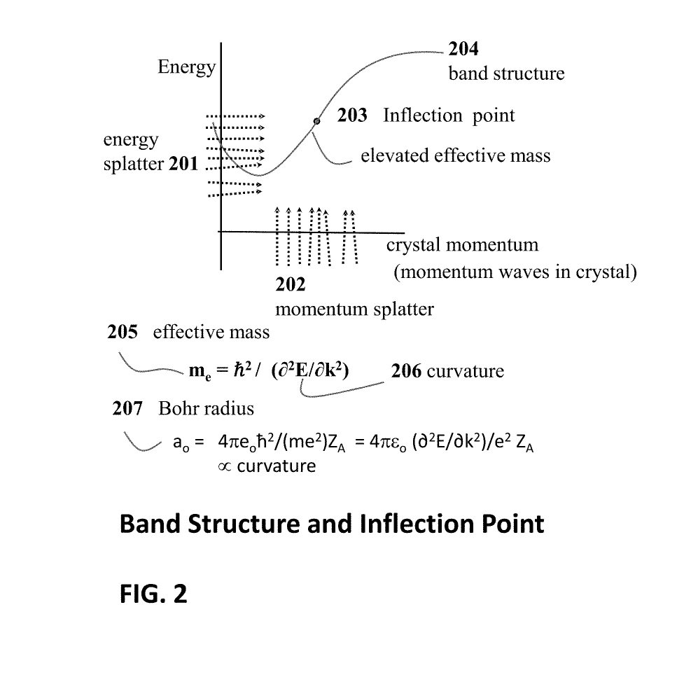

In some embodiments, a usefully high distribution of transient, elevated effective mass electron quasiparticles can be generated by system 500 when an inflection point of a band structure of the reaction crystallite 505 can be accessed by conduction band electrons of reaction crystallite 505. FIG. 2 illustrates a nominal band structure showing an inflection point and injection of both energy and momentum splatter for reaction crystallite 505.

The adsorption, desorption, absorption and insertion of the hydrogen atoms 506 into a reactant region 510 can energize a useful number of conduction band electrons of reaction crystallite 505 to have an energy and crystal momentum with values within a range of an inflection point where the low curvature of the band structure implies electrons with sufficiently elevated effective mass. This energizing can be achieved by ambient electron energy distribution when the inflection point energy is sufficiently close (approximately 1-2 electron volts) to the Fermi level. Several materials are identified with this approximately 1-2 electron volts property. The electrons also can be energized with crystal momentum to be near the inflection point. Adsorption, desorption, phase changes and injection of atoms, as well as heat in some cases, provide a spectrum of crystal momentum values that overlap the range of values near the inflection point. After insertion, some hydrogen becomes mobile in or on the crystal, causing it to become a delocalized hydrogen atom quasiparticle capable of chemical or nuclear reactions.

As suggested in FIG. 2 and further explained herein, when adsorption, desorption, absorption and injection of the hydrogen atoms 506 and hydrogen molecules 504 occur on the reaction crystallite 505, a splatter in the spectrum of both electron energy 201 (FIG. 2) and of crystal momentum 202 (FIG. 2) can result in a useful fraction of electrons around an inflection point 203 (FIG. 2) of a band structure 204 (FIG. 2) of reaction crystallite 505. The effective mass (mₑ) 205 (FIG. 2) is inverse to the curvature 206 (FIG. 2) of the band structure 204 (FIG. 2). The characteristic size of matter, given by the Bohr radius 207 (FIG. 2), can be proportional to a curvature 206 (FIG. 2). When the effective mass (mₑ ) 205 (FIG. 2) is large enough, then curvature 206 (FIG. 2) can be small enough for the Bohr radius 207 (FIG. 2) to be near the nuclear attraction boundary between the hydrogen atoms 506 and reactant nucleus 507.

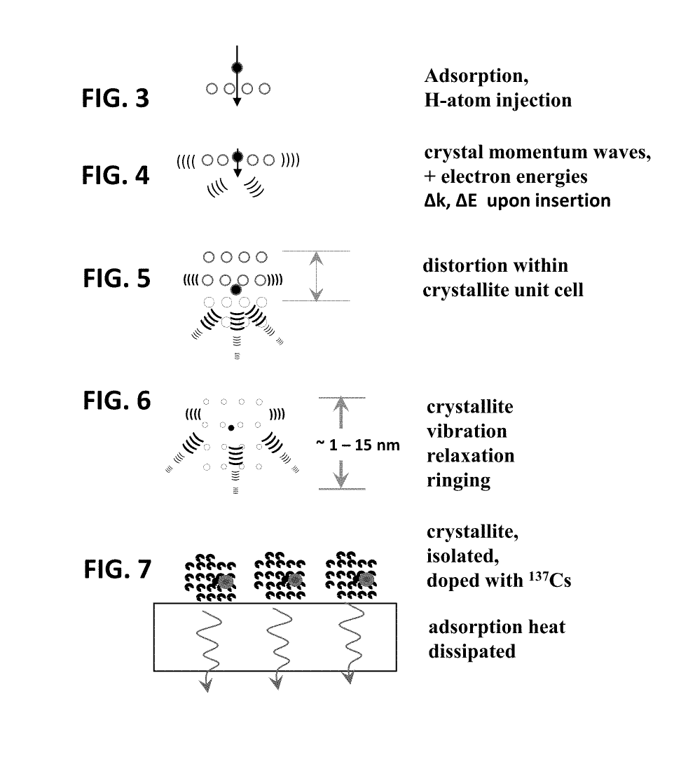

Turning ahead in the drawings, FIGS. 3-7 illustrate a process of injecting crystal momentum. For example, FIG. 3 illustrates a hydrogen atom can be injected into a reaction crystallite. Next, FIG. 4 illustrates the injection of the hydrogen atom into the reaction crystallite can cause waves of reaction crystallite atom motions. FIG. 5 illustrates the waves of the reaction crystallite atom motions reverberating, and FIG. 6 illustrates the waves beginning to relax and decay. The dimension of the decay can be approximately 1 to 15 nanometers. This defines the size parameter of the reaction crystallite. FIG. 7 illustrates particles in the dimension range of decay formed or placed on a suitable substrate. The chemical energy of absorption can be dissipated in the substrate.

Referring again to FIG. 1, some embodiments of system 500 can implement a technique developed for hydrogen atom arc welding to provide an efficient, controllable source of the hydrogen atoms 506 to adsorb, absorb or inject into the reaction crystallite 505. Hydrogen atoms 506 can be a stimulator and can become reactant hydrogen atoms after they become delocalized in or on the reaction crystallite 505. The hydrogen atom arc welding technique implemented by system 500 can use hydrogen gas 504, such as, for example, at atmospheric pressure. In system 500, the hydrogen gas 504 also can function as a convective heat sink 512 to prevent the reaction crystallite 505 from melting or vaporizing. In these or other embodiments, a substrate 508 can function as a conductive heat sink 509 to prevent the reaction crystallite 505 from melting or vaporizing. In some embodiments, the total heat conduction capacity of the substrate 508 can be at least an order of magnitude higher than the total heat generation capacity of the reaction crystallite 505 in thermal contact with the substrate 508. As a result, reaction rates at least an order of magnitude higher than would melt the reaction crystallite 505 can be facilitated. In some embodiments, convective heat sink 512 and conductive heat sink 509 can be in thermal communication with an external conductive heat sink 513.

In many embodiments, the substrate 508 can be thermally conductive and/or electrically insulating. Further, the substrate 508 can comprise materials that (1) are inert with hydrogen atoms or gas, (2) maintain integrity and function at operating temperatures of system 500, (3) are non-wetting with the reaction crystallite 505, and (4) do permit the reaction crystallite 505 to form globules, islands, clumps, or other similar forms, as opposed to allowing the reaction crystallite 505 to form a relatively smooth layer on the substrate 508.

While other techniques may be implemented to create the hydrogen atoms 506 at near atmospheric or higher pressure, the atomic hydrogen welder technique has demonstrated as much as 80% dissociation efficiency. In some embodiments, system 500 can comprise a hydrogen atom generator configured to apply the hydrogen welder technique. For example, the hydrogen atom generator can comprise an energy source and multiple electrodes 511. Further, the hydrogen atom generator can implement a voltage pulse during a first phase 501 to ionize an electrical conduction path in the hydrogen gas 504 between multiple electrodes 511. The voltage pulse can have a short duration (e.g., less than or equal to approximately 0.1 milliseconds) and a high voltage (e.g., approximately 1 kilovolt-5 kilovolts), and may use practically negligible current or energy. Further, the hydrogen atom generator can implement a second voltage pulse during a second phase 502 of relatively high current (e.g., approximately multiple micro-amps to hundreds of amps) and low voltage (e.g., approximately 1 volt-300 volts) to pour energy into an electrical arc, efficiently dissociating hydrogen molecules of the hydrogen gas 504 into the hydrogen atoms 506. Further, the hydrogen atom generator can implement a third phase 503 (i.e., a dead time during which no energy is supplied to the hydrogen gas 504 and during which diffusion transports the hydrogen atoms 506 to the reaction crystallite 505. Durations of the first phase 501, the second phase 502, and the third phase 503 can be selected and controlled dynamically to control temperatures of the substrate 508 and the hydrogen atoms 506, and to control reaction rates of the hydrogen atoms 506.

In further embodiments, the voltage pulse of the first phase 501 can comprise a relatively low current (e.g., greater than or equal to approximately multiple nano-amps and less than or equal to approximately multiple milli-amps) and a relatively high voltage (e.g., greater than or equal to approximately 2 kilovolts and less than or equal to approximately 4 kilovolts) to initiate conductivity in an ambient atmosphere of hydrogen gas 504. Further, hydrogen gas 504 can comprise a pressure of greater than or equal to approximately 0.01 atmosphere and less than or equal to approximately 100 atmospheres. In these or other embodiments, the voltage pulse of the second phase 502 can comprise a relatively low voltage (e.g., greater than or equal to approximately 1 volt and less than or equal to approximately 300 volts) and a relatively high current pulse (e.g., greater than or equal to approximately multiple micro-amps to less than or equal to approximately hundreds of amps) to energize a hydrogen arc, which is known to create hydrogen atoms with as much as 80% H₂ to H-atom energy efficiency. The third phase 503 can use a controlled dead time to stop adding energy for a dynamically determined period, as part of a control system.

In some embodiments, durations of the three phases of the hydrogen atom generator (i.e., first phase 501, second phase 502, and third phase 503) can be selected to limit the energy delivered to reaction crystallite 505 to ensure it is not destroyed, melted or vaporized. During a reset operation, the energy of the hydrogen atom generator of system 500 may be increased to cause reforming and re-deposition of reaction crystallite 505.

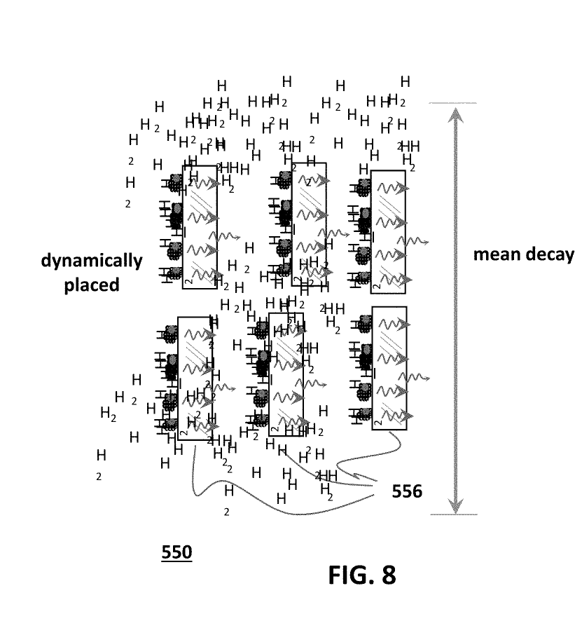

Turning ahead in the drawings, FIG. 8 illustrates a system 550, according to an embodiment. System 550 can be similar to system 500 (FIG. 1). For example, system 550 comprises multiple substrates 556 configured to be dynamically placed within a region of hydrogen atoms entrained in a hydrogen gas. Each of the multiple substrates 556 can be similar to substrate 508 (FIG. 1); the hydrogen atoms can be similar or identical to hydrogen atoms 506 (FIG. 1); and/or the hydrogen gas can be similar or identical to hydrogen gas 504 (FIG. 1).

As shown in FIGS. 1 & 8 system 500 and system 550 can maintain a pressure of hydrogen gas (e.g., hydrogen gas 504 (FIG. 1)) sufficient to allow both convective heat transport from the region of reaction and to force the hydrogen atoms (e.g., hydrogen atoms 506 (FIG. 1)) to flow to reaction regions (e.g., reactant region 510 (FIG. 1)) by diffusion transport in a gas instead of ballistic transport. For example, referring to FIG. 8 this permits configurations where the hydrogen flows between or among macroscopic features of a system (e.g., system 550), such as between multiple substrates 556 on which reaction crystallites are placed. This configuration allows sets of multiple substrates 556 to be dynamically placed into and out of the region of the hydrogen atoms during operation.

Referring again to FIG. 1, system 500 can use reaction crystallites (e.g., reaction crystallite 505) with small enough size that crystal momentum wave oscillations with wavelengths of the same order of magnitude size as a unit crystal of the reaction crystallites do not readily damp out. The reaction crystallites can ring with oscillations of their atoms for picoseconds. For example, the reaction crystallites (e.g., reaction crystallite 505) size (e.g., greatest dimension) is typically in the range of greater than or equal to approximately 1 and less than or equal to approximately 15 nanometers.

Reaction crystallites of system 500 (e.g., reaction crystallite 505) with the desired size can be naturally formed typically when metals are evaporated on dielectric insulators. For example, exemplary dielectric insulators comprise alumina, silicon, zirconia, porous versions of these, quartz, and the like.

Reaction crystallites of system 500 (e.g., reaction crystallite 505) can be formed using materials that readily adsorb and/or absorb hydrogen atoms 506 and/or its isotopes. Exemplary materials, those that form reaction crystallites of the range of sizes that adsorb/absorb hydrogen, can include, for example, one or more metals and alloys made of nickel, vanadium, titanium, palladium, zirconium, uranium, thorium, tantalum, transition metals, materials used in the walls of hot fusion reactors, and the like.

System 500 can be implemented with a reset operation to reform the reaction crystallites of system 500 (e.g., reaction crystallite 505). A reset can increase energy delivered to the reaction crystallites of system 500 (e.g., reaction crystallite 505) by control of the parameters of the hydrogen atom generator of system 500 beyond that needed to melt and vaporize some or all of them and redeposit and reform them on substrate 508. The reset may be controlled by adjustment of the three phases of the hydrogen atom generator (i.e., first phase 501, second phase 502, and third phase 503).

Whether formed by a reset operation or formed prior to use of system 500, the reaction crystallites of system 500 (e.g., reaction crystallite 505) can be initially formed as discontinuous (island) films. Island films provide a degree of electrical and mechanical isolation and prolong the duration of crystal momentum and electron energies. Such films can be formed during the intermediate stages of growth effected by the Volmer-Weber mechanism where both the size of most of the islands and the gaps between them are of the order of nanometers. Deposition of hydrogen bearing conductors on dielectric substrates (e.g., substrate 508) can form such island films, and especially where the substrates include refractory electrical insulator materials, such as alumina, zirconia, sapphire, quartz, pyrex, mica and the like. The reaction crystallites of system 500 (e.g., reaction crystallite 505) and substrate pairs can be selected from those where the reaction crystallites of system 500 (e.g., reaction crystallite 505) do not wet the substrate and are stable under operating temperature. The operating temperature for a reaction crystallite including nickel can be above 450 Celsius to enhance superpermeability.

In some embodiments, substrate 508 can act as heat sink in contact with the reaction crystallites of system 500 (e.g., reaction crystallite 505) to prevent destruction of the reaction crystallites of system 500 (e.g., reaction crystallite 505) during the energizing and stimulating process. Substrate 508 can be selected from those known to react slowly if at all with either molecular or atomic hydrogen, such as alumina, zirconia, pyrex and the like. Acting as a heat sink, substrate 508 may radiate the heat and may also be part of in thermal communication with convective heat sink 512.

In further embodiments, substrate 508 can be thermally conducting, electrically insulating, and/or not readily reactive with atomic or molecular hydrogen. The reaction crystallites of system 500 (e.g., reaction crystallite 505) can be formed or placed on substrate 508. Substrate 508 can be configured to dispose of heat, whether by conduction, convection or radiation.

In further embodiments, hydrogen gas 504 can comprise usefully dense gas of hydrogen molecules in contact with both the reaction crystallites of system 500 (e.g., reaction crystallite 505) and the multiple electrodes 511 used to create the hydrogen atoms 506. In some embodiments, a pressure of hydrogen gas 504 can be greater than or equal to approximately 0.01 atmosphere and less than or equal to approximately 100 atmospheres.

In some embodiments, system 500 can provide an efficient high flux of the hydrogen atoms 506 impinging on the reaction crystallites of system 500 (e.g., reaction crystallite 505), such as, for example, by implementing a hydrogen atom generator implementing the hydrogen welding technique discussed above. For example, in some embodiments, an arc can be struck between the multiple electrodes 511. The multiple electrodes 511 can comprise refractory conducting electrodes (e.g., electrodes made of tungsten) and can operate in a relatively high pressure of hydrogen gas 504 (e.g., 1 atmosphere). Electrode spacing of the multiple electrodes 511 can range from less than 1 millimeter to more than 50 millimeters. The reaction crystallites of system 500 (e.g., reaction crystallite 505) can be as much as 20 millimeters away from the hydrogen atom generator of system 500, which can be a distance within which hydrogen atoms have not recombined and are therefore useful.

The reaction crystallites of system 500 (e.g., reaction crystallite 505) can adsorb atomic hydrogen and thereby receive approximately 2 electron volts of energy directly into a reaction crystallite, and also adsorb and absorb an atom on or into the crystallite. The adsorption, desorption, and absorption can occur over a dimension typically limited to at most a few surface atoms, and thereby energize crystal momentum waves with wavelengths of order a few atoms. The short or small wavelength permits the crystal momentum to have components spanning the entire first Brillouin zone of the reaction crystallite. This spanning can be one condition for creating transient, elevated effective mass electron quasiparticles.

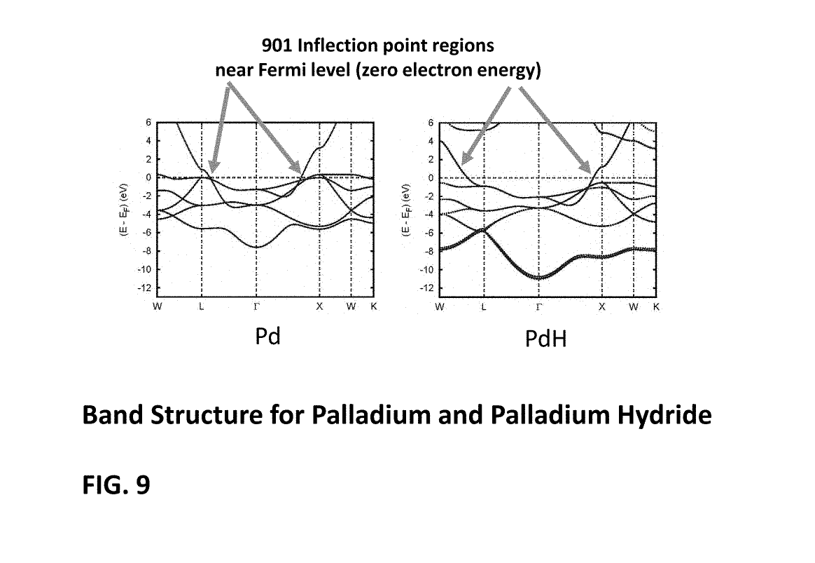

Crystallite materials and alloys can be selected for the reaction crystallites of system 500 (e.g., reaction crystallite 505) where the band structure reveals inflection points sufficiently near the crystallite Fermi level to be accessed by thermal or transiently hot electrons. Embodiments featuring adsorption or desorption of atomic hydrogen into a reaction crystallite thereby create a transient distortion of the crystallite, and as a result generate a spectrum of crystal momentum waves during the duration of the transient distortion. The dimension of such distortions ranges typically over no more than several atoms in a crystal unit cell, which implies the crystal momentum injection has wavelength extending over the entire first Brillouin zone. For example, in some embodiments, the wavelength can be less than approximately a dimension of a unit cell of the reaction crystallites of system 500 (e.g., reaction crystallite 505). In some embodiments, reaction crystallites formed by the Volmer-Weber mechanism by their nature advantageously have many facets. Multiple facets can provide multiple pairs of inflection points. Materials such as nickel, vanadium, titanium, tungsten, and palladium, for example, have band structures exhibiting multiple inflection points that can be thermally accessed, as shown at FIGS. 9-12 and discussed further below.

The reaction crystallites of system 500 (e.g., reaction crystallite 505) can be doped with radioactive isotopes known to have reaction branches where hydrogen and the isotopes together react due to the density of transient, elevated effective mass electron quasiparticles to form stable products. Such isotopes can include cesium-137 and/or strontium-90.

The reaction crystallites of system 500 (e.g., reaction crystallite 505) can be formed using the Volmer-Weber process. For example, nickel or nickel alloys can be evaporated or sputtered onto a ceramic such as alumina, pyrex, boron nitride or the like with deposition held to form a thickness less than or equal to approximately 15 nanometers. The thickness can refer to an average upper limit thickness where the islands formed during evaporation just begin to coalesce into a clumpy, partly continuous layer. In further embodiments, the thickness can be less than or equal to approximately 10 nanometers, such as, for example, when metals are evaporated on to ceramics such as alumina, pyrex, quartz, sapphire, to name a few. The partial isolation can permit electron energy to rise above thermal equilibrium because the electrons cannot readily leave the particle. Limiting the thickness to less than or equal to approximately 10 nanometers can allow long, picosecond crystal momentum wave decay times.

In many embodiments, radioactive materials to be transmuted can be included in the reaction crystallites of system 500 (e.g., reaction crystallite 505), either as a dopant or as a chemical applied to the crystallite surfaces.

The reaction crystallites of system 500 (e.g., reaction crystallite 505) with radioactive materials can then be exposed to low atomic number reactants, such as, for example, delocalized hydrogen, delocalized lithium, delocalized carbon, or delocalized oxygen atoms (not ions). For example, the low atomic number reactants can comprise delocalized reactant hydrogen atoms of hydrogen atoms 506. A flux of the low atomic number reactants then react with the reaction crystallites of system 500 (e.g., reaction crystallite 505) depositing both the energy associated with the adsorption and with the crystal momentum due to the adsorption/desorption and injection of the low atomic number reactants into or onto the reaction crystallites.

In some embodiments, the electrical isolation of the reaction crystallites of system 500 (e.g., reaction crystallite 505) can enhance a lifetime of approximately 1-2 electron volt hot electrons in the reaction crystallites of system 500 by an order of magnitude. The simultaneous energy and momentum waves may then cause a splatter of crystal momentum wavelengths and a splatter of electron energies in the reaction crystallites of system 500 (e.g., reaction crystallite 505). This splatter necessarily overlaps regions of the band structure diagram for the host material near inflection points. At inflection points, transient, elevated effective mass electron quasiparticles can be formed.

In some embodiments, the transient, elevated effective mass electron quasiparticles can have a transient, approximately 1 femtosecond in duration, during which a density of matter and the transient, elevated effective mass electron quasiparticles is proportional to the inverse cube of the quasiparticle mass (inverse cube of Bohr radius, which determines the size of chemical matter). While a position of an electron on the band structure changes at every electron collision (e.g., approximately every 10 femtoseconds), new transient, elevated effective mass electron quasiparticles are formed in their place until the momentum wave and energy decay, of order picoseconds later.

In some embodiments, these conditions can be sufficient to cause tri-particle reactions with low atomic number reactants (e.g., delocalized reactant hydrogen atoms of reactant hydrogen atoms 506), the transient, elevated effective mass electron quasiparticles, and the radioactive materials. When the transient, elevated effective mass electron quasiparticles have sufficient mass, the result can be an attraction reaction emitting either (1) energized electron quasiparticles or (2) ground state ions formed by a fracturing of the compound nucleus into energetic quasiparticles inside the nuclear boundary.

In some embodiments, system 500 can be totally enclosed.

In some embodiments, the reaction crystallites of system 500 (e.g., reaction crystallite 505) can be passivated. For example, passivation of nickel crystallite surfaces has been shown to increase the superpermeability of hydrogen atoms into the reaction crystallites with appreciable probabilities. In some embodiments, passivating the reaction crystallites of system 500 (e.g., reaction crystallite 505) can include oxidizing nickel at 800 Celsius and reducing it in pure hydrogen at 450 Celsius. In some embodiments, system 500 can use both hydrogen and refractory materials, permitting passivation and reduction in the same system when the system is operated above approximately 450 C.

In some embodiments, system 500 can energize an electron in a crystalline conductor to act as if it were a muon to be used in a muon catalyzed fusion system.

For example, when the effective mass of an electron in a conductor rises from its normal value to a value higher than a threshold, which is also an optimum value, a prompt binding of reactants can occur. At threshold, the chemical electron energy matches the ground state energy of the hydrogen-electron-reactant tri-particle. A transition occurs where almost all the binding energy is imparted to the electron between them, leaving the new nuclei in their ground state.

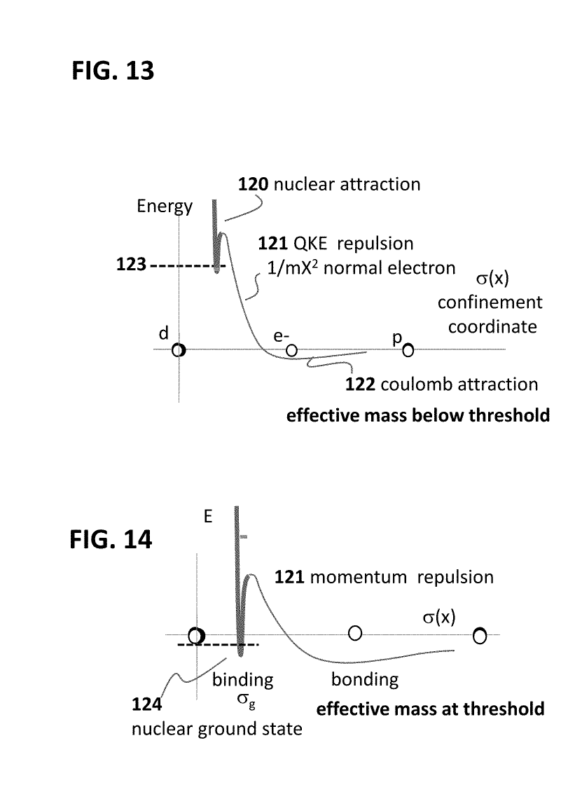

An “optimum” bond can use quasiparticles whose effective mass is just barely over the threshold. Turning ahead in the drawings, FIG. 13 illustrates a first plot of a total energy of a reactant/electron system as a function of a confinement coordinate of the electron. FIG. 13 shows a total energy of the reactant/electron system equal to the attractive binding energy 120, a repulsive, electron quantum kinetic energy (QKE) 121, and an attractive coulomb energy 122 when the electron begins in an initial state. A resulting nuclear attraction ground state 123 is above energy zero, and does not react. In a tri-particle with such lower effective mass, the ground state at nuclear dimensions can be above zero energy and therefore not a stable energy level of the system, and there is no transmutation or transition or reaction.

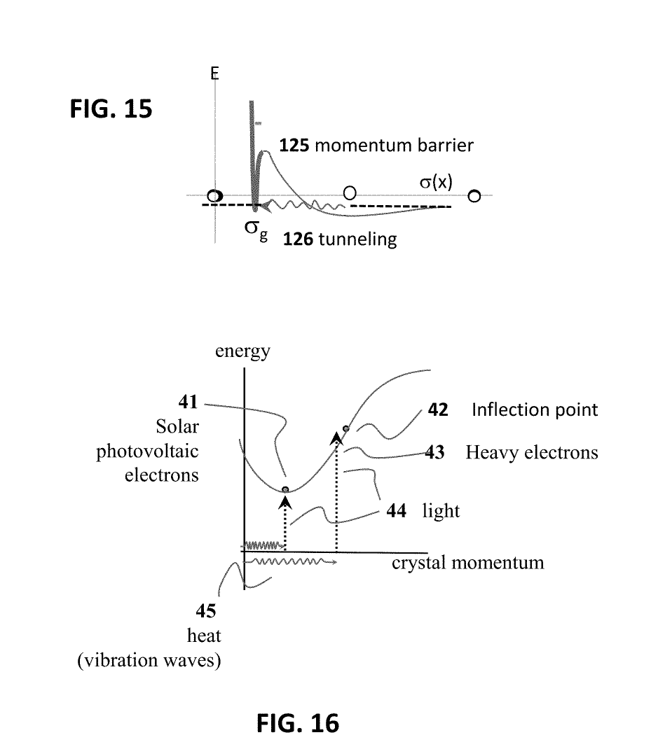

Turning ahead again in the drawings, FIG. 14 illustrates a second plot of an energy of the reactant/electron system of FIG. 13 as a function of a confinement coordinate of the electron; and FIG. 15 illustrates a third plot of an energy of the reactant/electron system of FIG. 13. The raising of effective mass lowers the electron QKE repulsion and lowers the ground state to below zero energy, thereby allowing it to be a stable state of the tri-particle. The newly formed bound state 124 permits the electron to bond with the reactants at nuclear dimensions. Because the effective mass is not high enough to shrink the chemical vibrational turning point down to nuclear dimensions, the bound state 124 can only be accessed by electron tunneling 126 through a repulsive momentum barrier 125 shown in FIG. 15. A derivation is provided below.

When the electron has a mass closer to the optimum, then a reaction can occur where reactants attract into each other in an attraction reaction, but instead of smashing together as in a normal reaction, the reaction energy is instead delivered to the sufficiently heavy, negative third particle between them—the heavy electron quasiparticle.

In a number of embodiments, the effective electron mass is proportional to the inverse of the curvature of the energy versus crystal momentum locus in the band structure diagram for a solid state material:

Effective mass=ℏ²/(∂²E/∂k²)

where E is the energy, k is the crystal momentum, and ℏ is the reduced Plank constant. This relationship is shown at FIG. 2. Transient, elevated effective mass electron quasiparticles can be generated when particular values of crystal momentum and energy are added to a crystallite. The particular values correspond to the region near the inflection point of a band structure diagram.

Turning ahead in the drawings, FIG. 16 illustrates a nominal band structure, showing a similarity of generating transient, elevated effective mass electron quasiparticles and converting photovoltaic energy in an indirect semiconductor such as silicon. Thermal vibration waves provide crystal momentum 45 addition. Photons or other energy sources 44 provide energy addition to produce solar photovoltaic electrons 41 or heavy electrons 43. Transient heavy electrons 43 can be formed near the inflection point 42. By comparison, when generating transient, elevated effective mass electron quasiparticles, the crystal momentum 45 addition can result from adsorption, desorption, absorption and particle injection.

Short wavelength distortions and localized energy injection can cause a splatter of crystal momentum and energy into the first Brillouin zone, and thereby necessarily overlap regions near an inflection point, where effective mass diverges, as shown in FIG. 2. A sparse distribution of heavy electron transients may result.

In each reported observation of anomalous transmutation or energy emission, a mechanism can be identified that simultaneously injects crystal momentum and energy. Some injection methods can use a “splatter,” which can be inefficient but at the same time can provide “shotgun” coverage near a band structure inflection point. Other embodiments can use more efficient injection methods producing a narrower and more concentrated “splatter” to more accurately target a band structure inflection point.

Adsorption or desorption of an atom or molecule into or out of a crystallite provides such a crystal momentum injection. Other methods include but are not limited to electrolysis, molecular or atomic adsorption, desorption and absorption, glow discharge injection, disintegration due to thermal, laser or e-beam irradiation, impact by gamma rays or electromagnetic radiation, plasmons, optical phonons, to name a few. The momentum injection can be strong, having a wavelength less than approximately that of the crystal unit cell (e.g., only a few atoms).

In some examples, the reaction can reliably start when the crystal momentum and energy switch is turned on.

Electrons close to an inflection point thereby become transient, elevated effective mass electron quasiparticles, which may result in a high density of the quasiparticles.

The inflection points 203 of FIG. 2 can very often involve large crystal momentum, which can be associated with atom-sized distortions smaller than the crystal unit cell. Crystal momentum k scales as 1/wavelength. A large crystal momentum impulse results in wavelengths comparable to the small unit cell size. The locations of the inflection points also can change with concentrations of additives, mandating a somewhat broadband injection of crystal momentum.

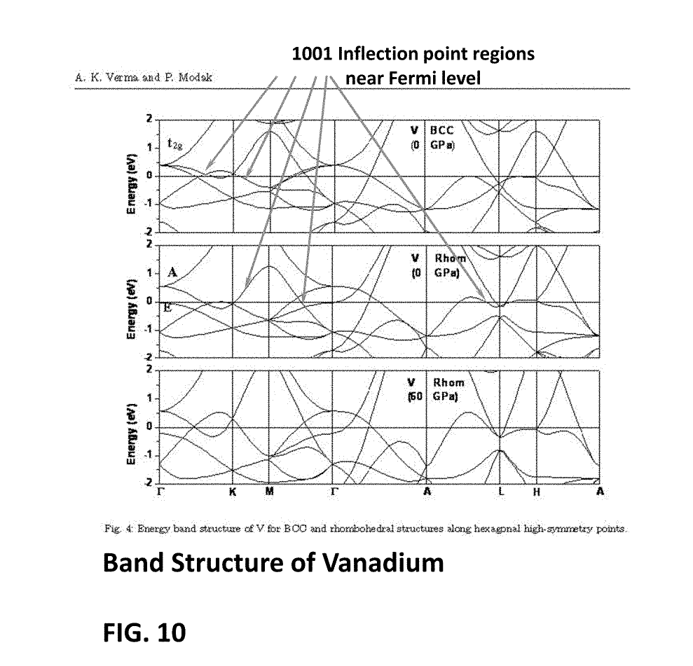

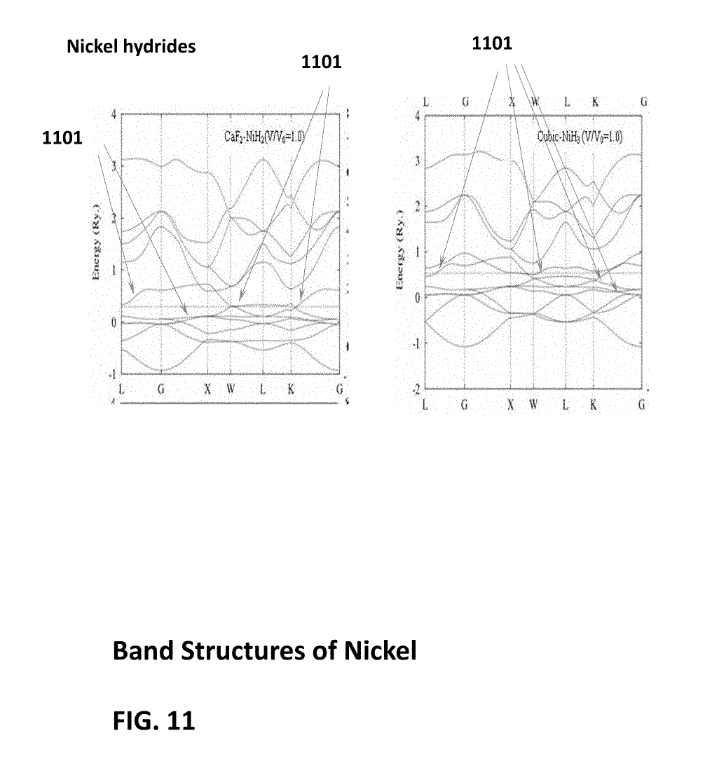

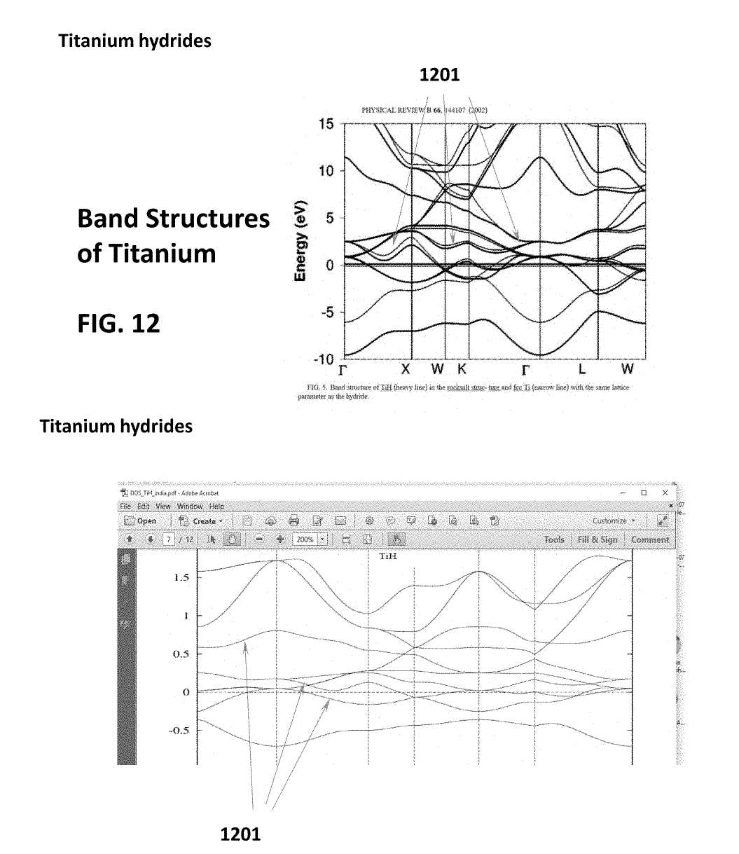

Similar inflection points can be seen in FIGS. 9-12. When the inflection point energy is near a Fermi level, heat supplies the electron energy, a distinct advantage. For example, FIG. 9 illustrates band structures for palladium and palladium hydride, showing inflection points 901 near the Fermi level; FIG. 10 illustrates band structures for vanadium, showing inflection points 1001 near the Fermi level; FIG. 11 illustrates band structures for nickel hydrides, showing inflection points 1101 near the Fermi level; and FIG. 12 illustrates band structures for titanium hydrides, showing inflection points 1201 near the Fermi level. The characteristic of an inflection point can be a change of curvature from positive to negative, and vice versa, with the inflection point region appearing to be a straight line segment.

Various specific embodiments include, for example, certain systems to generate and detect transient, elevated effective mass electron quasiparticles.

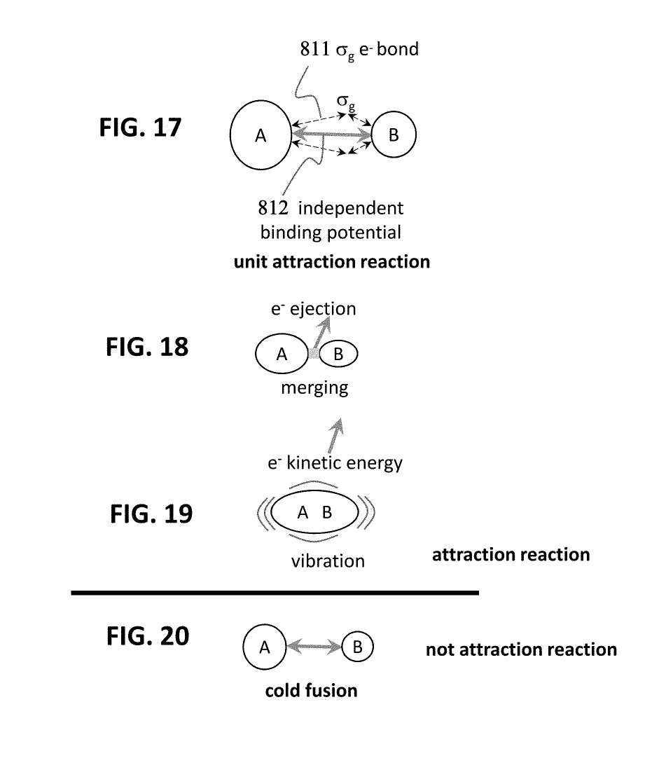

Turning ahead in the drawings, FIG. 17 illustrates a reactant A and a lower mass reactant B that are attracted to each other by an independent binding potential. Reactant A and reactant B do not need the electron between them to energetically bind together. The electron bonding potential, an electron sigma gerade bond 811, attracts both reactant A and reactant B to the electron between them, which electron does not have sufficient energy to escape the tri-particle. That binding energy also can be transferred to the electrons.

A unit attraction reaction can occur when both reactant A and reactant B can also sustain an electron bond of the “sigma gerade” type. A sigma gerade bond has a bonding electron wavefunction that places sufficient electron density between the reactants A and B to form at least a ground state. We use “unit reaction” because many atoms of type A with negative particles between them can have a common B reactant.

Turning to the next drawing, FIG. 18 illustrates a transition, or transmutation in the nuclear case, where reactant A and reactant B bind and the electron is ejected.

Turning again to the next drawing, FIG. 19 illustrates the energy associated with the electron bond and with the AB product bond being shared between the ejected electron and a vibration state of the AB product, and a relatively small recoil.

Turning again to the next drawing, FIG. 20 illustrates a circumstance where a unit attraction reaction does not result and a sigma ungerade bond forms, where the electron is bound to A or B. The ungerade bond does not create nor does it energize the attraction reaction. It only changes the size of chemistry. The electron is therefore not shown in FIG. 20 because it does not take part.

Accordingly, FIG. 20 shows a reaction without the bonding, sigma gerade bond. The electron is not energized by the binding potential and is antibonding, and therefore not shown. In the nuclear case, the result was a gamma emission instead of an electron emission. This is a cold form of fusion, not an attraction reaction, and has only been observed when a muon formed an antibonding orbital, the sigma ungerade bond, with reactant A or reactant B. This reaction can otherwise be impossible in the nuclear case.

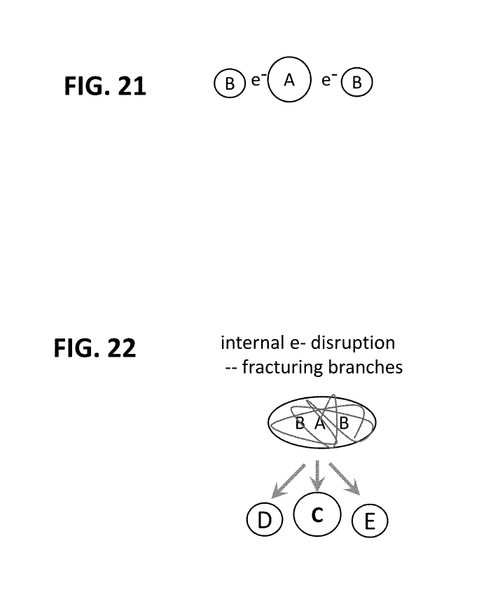

Turning ahead in the drawings, FIG. 21 illustrates combined unit reactions using a common reactant A. Meanwhile, Table 1 (below) shows some observed attraction reactions of reactant B and reactant A, including a reaction with radioactive Cesium-137.

TABLE 1

| B | A | Energy | product |
|---|---|---|---|
| COₐ | Oₐ | ~1.5 eV | CO₂ |
| Radical | Metal | ~0.6 eV | RM |
| N | O | ~3.1 eV | NO |
| p | d | ~5.3 MeV | ³He |
| p | ⁶²Ni | ~6 MeV | ⁶³Cu |
| p | ¹³⁷Cs | ~9 MeV | ¹³⁸Ba |

Further, Table 2 (below) shows combined unit reactions also observed, and in addition a combined unit reaction of radioactive cesium-137.

TABLE 2

| B | A | Energy | product |
|---|---|---|---|
| 2p | ⁶²Ni | ~13.8 MeV | ⁶⁴Zn |
| 2p | ¹³⁷Cs | ~15.3 MeV | ¹³⁹La |
| 2p | ⁶²Ni | ~16.4 MeV | ⁶⁶Zn |
| 4p | ¹³⁷Cs | ~28.6 MeV | ¹⁴¹Pr |

FIG. 22 illustrates combined unit reactions energize the bonding electrons inside a product nucleus BAB to form an intermediate nucleus. The energetic negative particles inside the nucleus attract nuclear protons and fracture the BAB product into stable sub-nuclei D, C and E.

Meanwhile, Table 3 (below) shows primary reactions producing the observed isotope production instead of energetic electron emission.

TABLE 3
2p + Ni⁶² → Zn⁶⁴ ~ 13.8 MeV

| | |
|---|---|
| → Fe⁵⁶ + 2 He⁴ | ~3.6 MeV |
| → Co + p + He⁴ | ~0.3 MeV |

2p + Ni⁶⁴ → Zn⁶⁶ + 16.4 MeV

| | |
|---|---|
| → Ni⁶² + He⁴ | 11.8 MeV |
| → Fe⁵⁸ + 2 He⁴ | 4.8 MeV |
| → Cr⁵⁴ + C¹² | 4.4 MeV |

4 * ¹H + ¹³⁷Cs → ¹⁴¹Pr + 28.6 MeV

| | |
|---|---|
| → ¹³³Cs + 2 * ⁴He | +26.8 MeV |

4 * ²H ¹³³Cs → ¹⁴¹Pr + 50.6 MeV

| | |
|---|---|
| → ¹³³Cs + 2 * ⁴He | +47.7 MeV |

The primary reaction provides the energy. The secondary reactions use the energy to access the fracturing branches. Note this combined unit attraction reaction model in some cases can produce helium emission. It is proposed that the transient density of elevated effective mass electron quasiparticles surrounding the heavier reactant A that initiated the reaction also encounter the alpha particle, and neutralize it by attaching two such heavy quasiparticles. Note that the density of such heavy quasiparticles is proportional to the cube of the effective mass, which can be the cube of a number of order 40 cubed, compared to 1 or 2 conduction band electrons in the normal material. The result is energetic neutral particle emission.

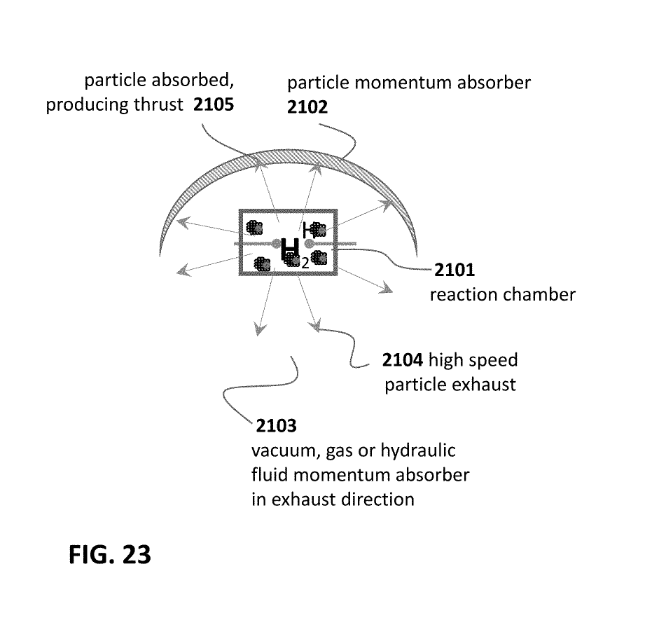

Turning ahead in the drawings, FIG. 23 illustrates a way to use an energetic neutral particle 2104 emission for propulsion. Energetic neutral particles such as 23 MeV helium have a particle velocity approaching 10% the speed of light. These velocities can be several orders of magnitude higher than current rocket exhaust molecular velocities (specific velocity). Because they are neutral, the particles also have a penetration range at least an order of magnitude higher than their charged counterparts. The particles may therefore more readily penetrate and escape an enclosure of a reaction chamber 2101. A particle momentum absorber 2102 can be placed in the direction of thrust to capture the momentum of the half of the particles emitted into an absorber direction 2105, producing thrust in that direction. The particles emitted in another direction 2103 can be directed away to a vacuum, gas stream or hydraulic fluid.

A brief derivation of the quantum kinetic energy imparted to the ejected electron follows. For the Schroedinger equation, Hamiltonian H is the sum of kinetic and potential energies T and V, with the electron quantum kinetic energy (Tₑ) and the kinetic energies of A and B (Tᵢₒₙ). V_{bind} represents the independent binding potential 812 (FIG. 8), and V_{bond} represents the electron bond potential, the sigma gerade electron σ_{g}e⁻ bond 811 (FIG. 8).

For the Heisenberg relation

Δx Δp≥ℏ/2

in its modern form, the Robertson-Schroedinger relation

σ²x σp≥(ℏ/2)²

is valid for all solutions to the Schroedinger equation.

Solving the equation allows equating the two sides of the equation and removes the “greater than or equal.”

The result is an equality that is a function K(n) of the electron excitation quantum number, n:

σ²x σ² p=(ℏ/2)²K(n).

K(n) takes on values close to or equal to 1 (unity) for ground state n.

In the center of mass coordinates,

<σ²p>=<p²>,

this leads directly to the energy associated with confining a bonding, sigma gerade wavefunction to a region characterized by the variance of the position σ²x.

<σ²p>/2m=<p²/2m>

=Quantum Kinetic Energy of confinement, QKE.

This leads to the relation defining the energy:

QKE=<Tₑ>=(ℏ/2)²K(n)/2 m σ²x.

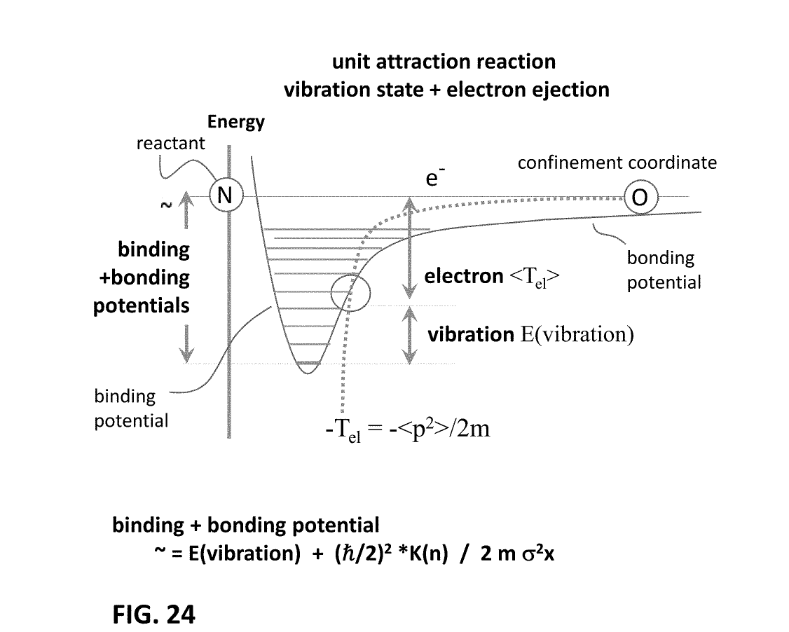

At any turning point, Tᵢₒₙ is zero. The binding and bonding potentials then partition into an energetic electron and internal vibration, with a small recoil, as shown in FIG. 24. FIG. 24 illustrates the relationship between binding, bonding and electron quantum kinetic energy as a function of effective mass.

At the moment of partition, the electron can give up its bonding energy, leaving it with only its share of binding energy.

The above brief derivation can represent the chemical physics of the unit attraction reactions described herein.

Some embodiments include a method of providing a system. The system can be similar or identical to system 500 (FIG. 1) or system 550 (FIG. 8). For example, the method can comprise providing one or more of the elements of system 500 or system 550, as described above.

Although the invention has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-24 may be modified, and that the foregoing discussion of certain of these embodiments does not necessarily represent a complete description of all possible embodiments.

Generally, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A system comprising:
a substrate;
one or more reaction crystallites over the substrate;
a hydrogen gas source configured to supply gaseous hydrogen molecules;
a hydrogen atom generator configured to generate hydrogen atoms from the gaseous hydrogen molecules and to cause the hydrogen atoms to be transported to the one or more reaction crystallites; and
a reactant;
wherein:
the one or more reaction crystallites are configured to receive the hydrogen atoms;
the one or more reaction crystallites are configured to form one or more transient, elevated effective mass electron quasiparticles in response to receiving the hydrogen atoms; and
the one or more transient, elevated effective mass electron quasiparticles are configured to stimulate attraction between the hydrogen atoms and the reactant and to cause transmutation of the reactant.

2) The system of claim 1 wherein:
the one or more reaction crystallites comprise a greatest dimension, and the greatest dimension is less than approximately 15 nanometers;
the one or more reaction crystallites are electrically conductive;
the one or more reaction crystallites are configured to absorb hydrogen; and
the one or more reaction crystallites thermally communicate with the substrate.

3) The system of claim 1 wherein:
the substrate is thermally conductive and is configured to sink heat away from the one or more reaction crystallites;
the substrate is electrically insulating;
the substrate is inert to hydrogen; and
the substrate is non-wetting with the one or more reaction crystallites.

4) The system of claim 1 wherein:
the gaseous hydrogen molecules entrain the hydrogen atoms; and
the gaseous hydrogen molecules are thermally convective and are configured to sink heat away from the one or more reaction crystallites.

5) The system of claim 1 wherein:
the one or more reaction crystallites are configured to form the one or more transient, elevated effective mass electron quasiparticles using energy received by the one or more reaction crystallites.

6) The system of claim 1 wherein:
the hydrogen atom generator comprises an energy source and multiple electrodes;
the energy source is configured to operate in three phases;
the energy source is configured to generate an ionizing energy pulse during a first phase of the three phases;
the energy source is configured to generate a dissociating energy pulse during a second phase of the three phases;
the ionizing energy pulse comprises a first quantity of energy; and
the dissociating energy pulse comprises a second quantity of energy greater than the first quantity of energy.

7) The system of claim 6 wherein:
the ionizing energy pulse comprises a first voltage and a first current;
the first phase comprises a first duration;
the dissociating energy pulse comprises a second voltage and a second current; and
the second phase comprises a second duration.

8) The system of claim 7 wherein:
the first voltage is greater than or equal to approximately 300 volts and less than or equal to approximately 4000 volts;
the first current is greater than or equal to multiple pico-amps and less than or equal to multiple milliamps;
the first duration is less than or equal to 0.1 millisecond;
the second voltage is greater than or equal to approximately 0.5 volt and less than or equal to approximately 300 volts;
the first current is greater than or equal to multiple micro-amps and less than or equal to multiple hundreds of amps; and
the first duration is greater than or equal to 0.1 millisecond and less than or equal to 0.1 second.

9) The system of claim 1 wherein:
the one or more reaction crystallites comprise at least one of nickel, titanium, palladium, vanadium, tungsten, silver, copper, zirconium, uranium, thorium, or a transition metal.

10) The system of claim 1 wherein:
the reactant comprises at least one radioactive element.

11) The system of claim 10 wherein:
the at least one radioactive element comprises at least one of cesium-137 or strontium-90.

12) A system comprising:
a substrate;
one or more reaction crystallites over the substrate;
a hydrogen gas source configured to supply gaseous hydrogen molecules;
a hydrogen atom generator configured to generate hydrogen atoms from the gaseous hydrogen molecules and to cause the hydrogen atoms to be transported to the one or more reaction crystallites; and
a reactant;
wherein:
the one or more reaction crystallites are configured to receive the hydrogen atoms;
the one or more reaction crystallites are configured to form one or more transient, elevated effective mass electron quasiparticles in response to receiving the hydrogen atoms;
the one or more transient, elevated effective mass electron quasiparticles are configured to stimulate attraction between the hydrogen atoms and the reactant and to cause transmutation of the reactant;
the one or more reaction crystallites comprise a greatest dimension, and the greatest dimension is less than approximately 15 nanometers;
the one or more reaction crystallites are electrically conductive;
the one or more reaction crystallites are configured to absorb hydrogen;
the one or more reaction crystallites thermally communicate with the substrate. the substrate is thermally conductive and is configured to sink heat away from the one or more reaction crystallites;
the substrate is electrically insulating;
the substrate is inert to hydrogen;
the substrate is non-wetting with the one or more reaction crystallites. the gaseous hydrogen molecules entrain the hydrogen atoms;
the gaseous hydrogen molecules are thermally convective and are configured to sink heat away from the one or more reaction crystallites;
the one or more reaction crystallites are configured to form the one or more transient, elevated effective mass electron quasiparticles using energy received by the one or more reaction crystallites.

13) The system of claim 12 wherein:
the hydrogen atom generator comprises an energy source and multiple electrodes;
the energy source is configured to operate in three phases;
the energy source is configured to generate an ionizing energy pulse during a first phase of the three phases;
the energy source is configured to generate a dissociating energy pulse during a second phase of the three phases;
the ionizing energy pulse comprises a first quantity of energy; and
the dissociating energy pulse comprises a second quantity of energy greater than the first quantity of energy.

14) The system of claim 13 wherein:
the ionizing energy pulse comprises a first voltage and a first current;
the first phase comprises a first duration;
the dissociating energy pulse comprises a second voltage and a second current; and
the second phase comprises a second duration.

15) The system of claim 14 wherein:
the first voltage is greater than or equal to approximately 300 volts and less than or equal to approximately 4000 volts;
the first current is greater than or equal to multiple pico-amps and less than or equal to multiple milliamps;
the first duration is less than or equal to 0.1 millisecond;
the second voltage is greater than or equal to approximately 0.5 volt and less than or equal to approximately 300 volts;
the first current is greater than or equal to multiple micro-amps and less than or equal to multiple hundreds of amps; and
the first duration is greater than or equal to 0.1 millisecond and less than or equal to 0.1 second.

16) The system of claim 12 wherein:
the one or more reaction crystallites comprise at least one of nickel, titanium, palladium, vanadium, tungsten, silver, copper, zirconium, uranium, thorium, or a transition metal.

17) The system of claim 12 wherein:
the reactant comprises at least one radioactive element.

18) The system of claim 17 wherein:
the at least one radioactive element comprises at least one of cesium-137 or strontium-90.
